(19) United States
(12) Patent Application Publication
(10) Pub. No.: US 2021/0309507 A1
(43) Pub. Date: Oct. 7, 2021

(54) POCKETED SPRING UNIT AND METHOD OF MANUFACTURE

(71) Applicant: HS Products Limited, Leeds (GB)

(72) Inventors: Simon Spinks, Leeds (GB); Richard Essery, Leeds (GB); David Clare, Leeds (GB)

(21) Appl. No.: 17/349,899

(22) Filed: Jun. 16, 2021

Related U.S. Application Data
(63) Continuation of application No. PCT/GB2019/053644, filed on Dec. 20, 2019.

(30) Foreign Application Priority Data
Dec. 20, 2018 (GB) 1820838.9

(51) Int. Cl. B68G 9/00; A47C 27/06

(52) U.S. Cl. CPC B68G 9/00; A47C 27/064

(57) ABSTRACT

A pocketed spring unit comprising an array of springs 120 located in pockets 180 formed by discrete superposed webs 140 of pocketing material joined together by welds W between the springs, wherein the welds are located at alternately opposite ends of the pocketed springs.

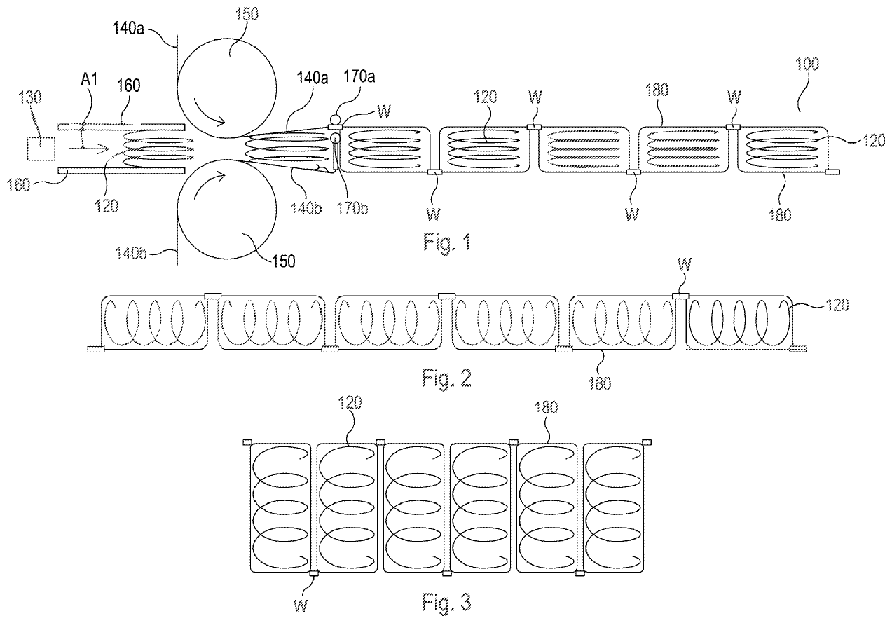

FIG. 1 shows generally a pocketed spring unit at a first stage of manufacture. A row of coil springs 120 (only the end one of which is visible) is introduced by an inserter mechanism 130 into position between axially disposed webs 140a and 140b of pocketing material. The webs 140a and 140b are fed from supply reels (not shown via guide rollers 150. The springs 120 are partly compressed and are pushed between plates 160 towards the webs 140 by the inserter 130 in the direction of Arrow A1.

Once the springs are between the webs 140 a pair of ultrasonic welding tools 170a and 170b joins the webs together at weld locations W between the springs to form individual pockets 180 for the springs. One of the tools is a sonotrode/horn and the other is a base/anvil. Successive rows of springs are encapsulated by welds W that alternate between the axial ends of the springs, so that one is at an upper axial end and the next is at a lower axial end. The webs 140 may also be welded together along their edges (not shown)—i.e. at the ends of the rows—and between adjacent springs in the same row, to fully form the pockets.

### CROSS REFERENCE TO RELATED APPLICATIONS

The present application is a continuation application of International Application No. PCT/GB2019/053644, entitled “Pocketed Spring Unit and Method of Manufacture,” filed on Dec. 20, 2019, which claims priority to GB Application No. 1820838.9, filed Dec. 20, 2018, the contents of each of which are herein incorporated by reference in their entireties.

The present invention relates to a pocketed spring unit, of the kind that may be used in an upholstered article, such as a mattress or similar.

Pocketed springs, otherwise known as encased springs, are used in upholstered articles such as mattresses. Most pocketed spring units comprise coil springs encased individually in pockets of fabric material made by folding over a sheet of fabric to form two leaves that envelope the springs, and then attaching the leaves together between the springs so as to form a linear string of springs. The strings are then joined to form an array of springs as a pocketed spring unit. The joining of the strings together to form an array is achieved either by gluing the strings together along the cylindrical surfaces of the pocketed springs, one string to the next, and so on until the unit is formed, or else by arranging the strings beside each other in the manner of an array, and then gluing sheets of fabric to the cylindrical ends of the pocketed springs, above and/or below, so as to form the unit.

In view of its relatively high cost, there is a desire to reduce the quantity of adhesive used in the manufacture of such units.

An alternative method of forming an array of pocketed springs is described in our European Patent No. EP 19939473 in which springs are introduced between axially superposed sheets of material that are then joined at locations between the springs and at the edges of the unit, preferably by welding, such as by ultrasonic welding.

This method is particularly suited to the manufacture of a pocketed spring unit in which the springs are typically shorter in axial length than the coil of largest diameter, when the spring is held in a partly compressed state inside the pocket. The method is less suited to taller springs, such as are used in the first-mentioned method above.

Embodiments of the present invention aim to provide a pocketed spring unit and method of manufacture in which at least some of the problems of the prior art are addressed.

The present invention is defined in the attached independent claims, to which reference should now be made. Further, preferred features may be found in the sub-claims appended thereto.

According to one aspect of the present invention, there is provided a pocketed spring unit comprising an array of springs located in pockets formed by superposed webs of pocketing material joined together by welds between the springs, wherein the welds are located at alternately opposite ends of the pocketed springs.

The alternate axial end welds apply to the springs as they move in the direction of travel of the rows during encapsulation.

In a preferred arrangement the webs are joined by a single weld between the pockets.

Preferably, in at least one direction of the array, each pocket is connected to one neighbouring pocket by a weld at one axial end and is connected to another neighbouring pocket by a weld at an opposed axial end.

In a preferred embodiment the pocketed spring unit is fan-folded, with the positions of the folds substantially coinciding with the positions of the welds.

Adjacent rows of pocketed springs may be held together at their ends opposite the welds by connections, which connections may comprise mechanical connectors and/or adhesive connections. The mechanical connectors may, for example, comprise coupling rings or loops which may engage one or more turns of the springs.

In a preferred arrangement the pocketed spring unit may have a cover sheet attached to one or both axial ends of the pockets. The or each cover sheet is preferably welded to the pocketing material. In a particularly preferred arrangement the or each cover sheet may be welded to the pocketing material at the locations of the welds forming the pockets.

According to another aspect of the present invention, there is provided a method of manufacturing a pocketed spring unit comprising an array of springs located in pockets, the method comprising inserting successive rows of springs between axially spaced webs of pocketing material, joining the webs at locations between the springs by welding, and wherein the welds between successive rows of pockets are located alternately at opposite axial ends of the springs.

The webs are preferably separate, or discrete, sheets of material.

In a preferred arrangement, the method comprises the step of turning the springs in their pockets. The method may comprise inserting the springs between the sheets in an at least partly splayed configuration. Splaying the springs promotes turning of the springs in their pockets.

The method preferably includes the step of fan-folding the array of pocketed springs after turning the springs in their pockets. The fan folding preferably includes making folds in substantially the locations of the welds forming the pockets.

The method may include connecting at least some of the pocketed springs after folding, wherein the connections are at axial ends of the pockets opposed to the positions of the welds. The method may include connecting the pocketed springs by adhesive and/or by coupling rings/loops which engage one or more coils of springs in adjacent rows.

The method may include alternately advancing the webs of pocketing material relative to each other between spring insertion steps.

The method may include forming hinges between rows of springs by making a weld between successive rows, which weld may be a continuous weld. Preferably the continuous weld has a length in the direction of travel of the rows that forms a hinge width in the finally assembled unit.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

FIG. 1 shows schematically a portion of a pocketed spring unit, comprising a two-dimensional array of pocketed springs, at a first stage of manufacture;

FIG. 2 shows the unit of FIG. 1 at a second stage;

FIG. 3 shows the unit of FIGS. 1 and 2 in a fan-folded configuration, at a third stage

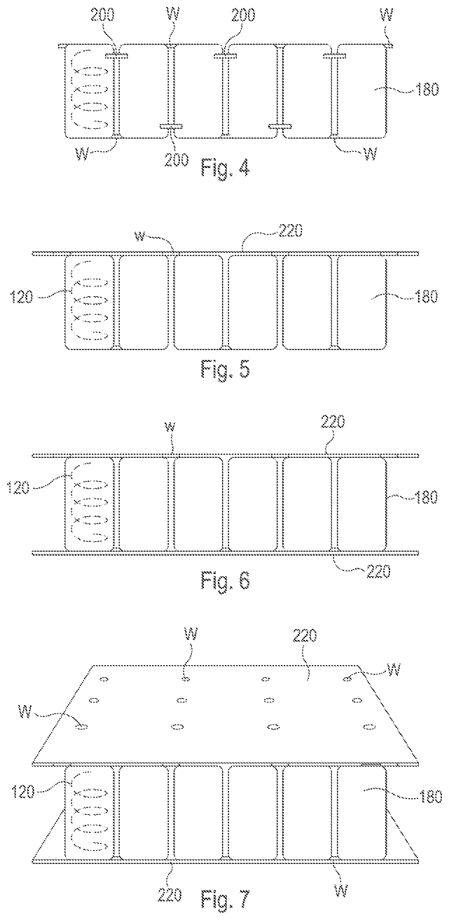

FIG. 4 shows the unit with additional fixings;

FIG. 5 shows the unit with a top sheet attached;

FIG. 6 shows the unit with both top and bottom sheets attached;

FIG. 7 shows the unit in a schematic perspective view;

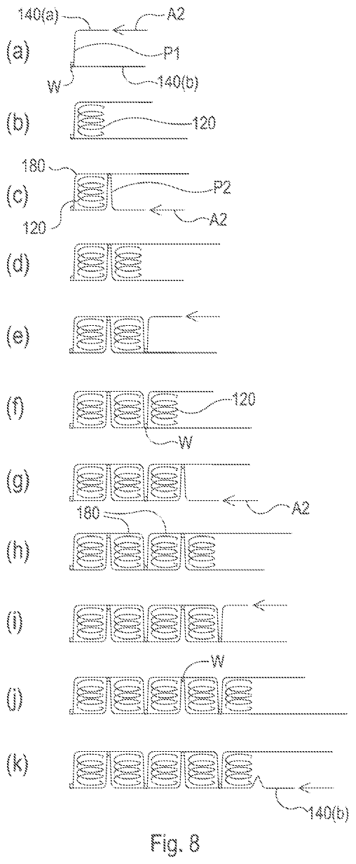

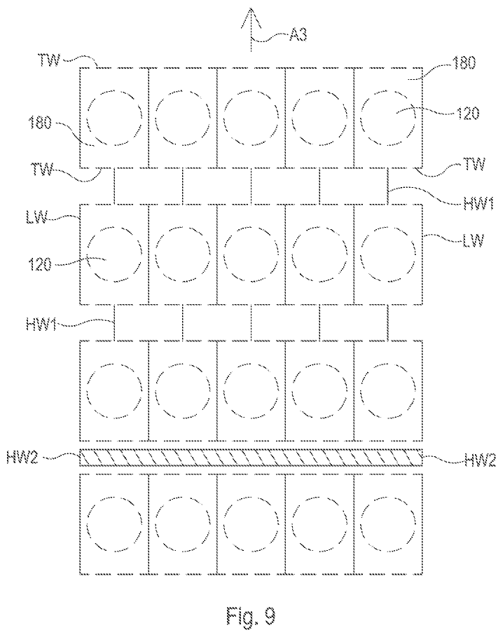

FIG. 8 shows, schematically, an alternative method for forming the pockets; and

FIG. 9 shows, schematically, examples of methods for forming hinges in the pocketed spring unit, for subsequent folding of the unit.

Turning to FIG. 1, this shows, generally a pocketed spring unit at a first stage of manufacture. A row of coil springs 120 (only the end one of which is visible) is introduced by an inserter mechanism 130 into position between axially disposed webs 140a and 140b of pocketing material. The webs 140a and 140b are fed from supply reels (not shown via guide rollers 150. The springs 120 are partly compressed and are pushed between plates 160 towards the webs 140 by the inserter 130 in the direction of Arrow A1.

Once the springs are between the webs 140 a pair of ultrasonic welding tools 170a and 170b joins the webs together at weld locations W between the springs to form individual pockets 180 for the springs. One of the tools is a sonotrode/horn and the other is a base/anvil. Successive rows of springs are encapsulated by welds W that alternate between the axial ends of the springs, so that one is at an upper axial end and the next is at a lower axial end. The webs 140 may also be welded together along their edges (not shown)—i.e. at the ends of the rows—and between adjacent springs in the same row, to fully form the pockets.

FIG. 2 shows the array of springs at a next stage, after the springs 120 have been turned in their pockets 180. This can be achieved by passing the pocketed springs over (or under) a flap (not shown). The springs are in any case predisposed to turn as they are initially under compression in their pockets. Because of the positioning of the welds W, turning the springs allows them to expand a little further, leading to the configuration shown in FIG. 2.

At the next stage the pocketed springs are fan folded along their welds W, which are located at the corners of adjacent pockets. The thus-folded array is shown in FIG. 3.

FIG. 4 shows the pocketed spring unit as folded in FIG. 3, but with connectors in the form of metal rings 200 holding together the adjacent rows of pocketed springs at opposite axial ends to the welds W to prevent the unit from unfolding. The rings physically link with a coil of wire from adjacent springs. Not all of the adjacent springs need be joined together in this way. To ensure that the unit does not unfold it is only necessary to connect a few springs across each row with its neighbour on the adjacent row. As an alternative to connector rings, adhesive between adjacent pockets could be used for this purpose, or else further welds could be made using welding tools (not shown) that penetrate the pockets of springs in adjacent rows, at several places across the width of a row.

FIG. 5 shows an embodiment of pocketed spring unit in which the fan-folded unit has been welded on one side (i.e. at one axial end of the springs) to a cover sheet 210. As well as providing additional support to the unit, the cover sheet also serves to retain the unit it its folded configuration—even without the need for additional connections such as rings or adhesive between adjacent pockets. The cover sheet can conveniently be directly welded ultrasonically to the pocket material. The welds joining the cover sheet to the pockets can be conveniently co-located with the welds W forming the pockets.

FIG. 6 shows another variant of unit in which a cover sheet has been welded to both sides, for still greater support and stability.

FIG. 7 is a schematic perspective view of the embodiment of FIG. 6, showing welds W that attach the upper cover sheet to the pockets below.

The springs 120 may be inserted between the sheets 140 in a splayed configuration. In this configuration at least some of the coils of the spring are not axially aligned but are displaced radially with respect to at least one neighbouring coil. Coils that are splayed in this way are predisposed to turn within the pocket so that the axis becomes rotated by ninety degrees.

Splaying the springs can be achieved, for example, by putting a sloping face on the inserter tool 130 (FIG. 1) so that as it engages the spring it begins displacing coils at different times, thereby splaying, or slanting the spring.

FIG. 8 shows schematically a series of steps in an alternative method for forming the pockets. The view shown is a schematic section, and therefore only a single row of pocketed springs can be seen, but the reality is that the unit is a two dimensional array of pocketed springs and what can be seen happening in steps 8(a) to 8(k) is simultaneously happening to a row of springs extending into the page.

At step (a) the two webs 140(a) and 140(b) are brought together in the direction of Arrow A2 and a weld W is made, preferably ultrasonically. This is achieved by advancing upper web 140(a) whilst keeping lower web 140(b) stationary, or alternatively advancing the upper web faster than the lower web, so that a surplus of pocketing material forms a front pocket wall P1. At Step (b) a spring is inserted.

At Step (c) the lower web 140(b) is advanced relative to upper web 140(a) to form a rear pocket wall P2 and the webs are welded together to close the spring 120 in the pocket 180. At Step (d) the next spring 120 (strictly speaking a row of springs 120) is inserted between the webs. Step (e) repeats Step (a) and then Step (f) repeats Step (b). At each row of springs one of the two webs is advanced relative to the other to form a pocket wall, a welding takes place and then the next spring is inserted, before the other web is relatively advanced to form the next pocket wall, and so on. Step (k) shows the lower web 140(b) just at the start of its relative advancement and before the pocket wall is formed.

The alternate relative advancement of the webs may be achieved in a number of ways, for example by the control of independent rollers (not shown) which push the webs along or else by grasping and pulling the webs, for example using suction devices (not shown). This offset feeding of the material webs allows for the formation of hinges between rows of pocketed springs in a manner that is very efficient in the use of pocketing material.

FIG. 9 shows in schematic plan view some different styles of hinges between successive rows of pocketed springs.

The springs 120 are encapsulated in pockets 180 by welding, preferably by ultrasonically welding webs 140 of pocketing material, as described above.

As the pocketed spring unit travels in the direction of Arrow A3, the sides of the pockets are formed by longitudinal welds LW and the ends of the pockets are formed by transverse welds TW. Either or both types of weld may be continuous or else may be intermittent or patterned.

Between the successive rows of pocketed springs hinge welds HW are formed which will later allow the fan-folding of the pocketed spring unit, as described earlier.

The hinge welds HW may take a number of different forms. Two examples are shown. The first two rows shown in FIG. 9 are short longitudinal welds HW1 at spaced locations, generally towards the middle of the pockets. They could alternatively be located closer to or in line with the longitudinal welds LW that form the sides of the pockets.

The second example shown HW2 is a thicker transverse weld.

In each case the hinge weld HW must have some extent (length) in the longitudinal direction A3 to form the hinge. In the finished article the width of the hinge is determined by the longitudinal extent of the hinge weld HW.

It will be appreciated that the hinge welds HW may be of various shapes and may be continuous, intermittent or patterned in the longitudinal direction (ie parallel with the direction of Arrow A3) and/or in the transverse direction (ie transverse to the direction of Arrow A3).

Whilst the example given above is of ultrasonic welding, other methods of welding/joining/bonding could be used, such as heat sealing, for example.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A pocketed spring unit comprising an array of springs located in pockets formed by superposed webs of pocketing material joined together by welds between the springs, wherein the welds are located at alternately opposite ends of the pocketed springs.

2. A pocketed spring unit according to claim 1, wherein the webs are joined by a single weld between the pockets.

3. A pocketed spring unit according to claim 1, wherein in at least one direction of the array, each pocket is connected to one neighbouring pocket by a weld at one axial end and is connected to another neighbouring pocket by a weld at an opposed axial end.

4. A pocketed spring unit according to claim 1, wherein the pocketed spring unit is fan-folded, with the positions of the folds substantially coinciding with the positions of the welds.

5. A pocketed spring unit according to claim 1, wherein adjacent rows of pocketed springs are held together at their ends opposite the welds by mechanical connectors.

6. A pocketed spring unit according to claim 5, wherein the mechanical connectors comprise coupling rings or loops which engage one or more turns of the springs.

7. A pocketed spring unit according to claim 1, wherein the pocketed spring unit has a cover sheet attached to one or both axial ends of the pockets.

8. A pocketed spring unit according to claim 7, wherein the or each cover sheet is welded to the pocketing material.

9. A pocketed spring unit according to claim 8, wherein the or each cover sheet is welded to the pocketing material at the locations of the welds forming the pockets.

10. A method of manufacturing a pocketed spring unit comprising an array of springs located in pockets, the method comprising inserting successive rows of springs between axially spaced webs of pocketing material, joining the webs at locations between the springs by welding, and wherein the welds between successive rows of pockets are located alternately at opposite axial ends of the springs.

11. A method according to claim 10, wherein the method comprises the step of turning the springs in their pockets.

12. A method according to claim 11, wherein the method includes the step of fan-folding the array of pocketed springs after turning the springs in their pockets.

13. A method according to claim 12, wherein the fan folding preferably includes making folds in substantially the locations of the welds forming the pockets.

14. A method according to claim 12, wherein the method includes connecting at least some of the pocketed springs after folding, wherein the connections are at axial ends of the pockets opposed to the positions of the welds.

15. A method according to claim 14, wherein the method includes connecting the pocketed springs by adhesive and/or by coupling rings/loops which engage one or more coils of springs in adjacent rows.

16. A method according to claim 10, comprising alternately advancing the webs of pocketing material relative to each other between spring insertion steps.
